(19) United States
(12) Patent Application Publication
(10) Pub. No.: US 2026/0354628 A1
(43) Pub. Date: Nov. 12, 2026

(54) TOWEL SYSTEM

(71) Applicant: THE JAKES GROUP LLC, O'Fallon, IL (US)

(72) Inventors: Christopher Lee JAKES, O'Fallon, IL (US); Brianne Meghan JAKES, O'Fallon, IL (US)

(21) Appl. No.: 19/668,502

(22) Filed: May 5, 2026

Related U.S. Application Data
(60) Provisional application No. 63/800,567, filed on May 6, 2025.

(51) Int. Cl. A47K 10/02; B32B 5/26; B32B 7/02

(52) U.S. Cl. CPC A47K 10/02; B32B 5/26; B32B 7/02; B32B 2432/00

(57) ABSTRACT

Embodiments disclosed herein related to a towel system with a first portion and a second portion. The first portion may be for drying a user’s body, and the second portion may be for drying a user’s face. The first portion may be larger than the second portion. The first portion and the second portion may be coupled to each other along an edge of each portion. The towel system may include various features, including loops, pockets, and opening for receiving a user’s arm or hand. The loops may allow the towel system to hang dry and prevent contact between at least one side of the first portion and at least one side of the second portion. The towel system described herein may allow for more hygienic cleaning compared to existing towels.

### CROSS-REFERENCE

This application claims the benefit of U.S. Provisional Application No. 63/800,567, filed May 6, 2025, which is incorporated herein in its entirety by reference thereto.

### BACKGROUND

The present disclosure relates to a towel system. More particularly, embodiments relate to a towel system with a first portion for drying a user’s body and second portion for drying a user’s face.

### BRIEF SUMMARY

Some embodiments are directed to a towel system that includes a first portion, a second portion, and a loop. In some embodiments, the first portion may have a first length and a first width, and the second portion may have a second length and a second width. In some embodiments, the first length is greater than the second length, and the first width is greater than the second width. In some embodiments, an edge of the second portion is coupled to an edge of the first portion. In some embodiments, the loop is for hanging the towel system and is disposed proximate to the coupling between the edge of the first portion and the edge of the second portion.

In any of the various embodiments disclosed herein, the first portion may have a density from 50 GSM to 1000 GSM, and wherein the second portion has a density from 50 GSM to 1000 GSM.

In any of the various embodiments disclosed herein, the second portion may have a fabric density different than a fabric density of the first portion.

In any of the various embodiments disclosed herein, the first portion may be made of a first material and the second portion may be made of a second material that is different than the first material.

In any of the various embodiments disclosed herein, the second portion may be removably coupled to the first portion.

In any of the various embodiments disclosed herein, the second portion may be removably coupled by a fastening system.

In any of the various embodiments disclosed herein, the fastening system may include at least one of a snap fit fastener, a hook and loop fastener, a zipper, an adhesive, or combinations thereof.

In any of the various embodiments disclosed herein, the second portion may be fixedly coupled to the first portion. In any of the various embodiments disclosed herein, the second portion may be fixedly coupled by at least one of stitching, adhesive, or a combination thereof.

In any of the various embodiments disclosed herein, the second portion may have a rectangular shape, a trapezoidal shape, a triangular shape, an elliptical shape, or an oval shape.

In any of the various embodiments disclosed herein, the second portion comprises a first side, a second side, and an opening between the first side and the second side that may be configured to receive a user’s hand.

In any of the various embodiments disclosed herein, the towel system may include a pocket coupled to the second portion configured to receive a user’s hand.

In any of the various embodiments disclosed herein, the loop may be disposed proximate to the coupling between the edge of the first portion and the edge of the second portion such that, when the towel system is hanging, a first side of the second portion faces away from a first side of the first portion and a second side of the second portion faces a second side of the first portion.

Some embodiments are directed to a towel system that includes a first portion, a second portion. In some embodiments, the first portion includes a first edge and is configured to dry a first body portion of a user’s body. In some embodiments, the second portion extends out from the first portion and is configured to dry a second body portion of a user’s body different than the first body portion of the user’s body. In some embodiments, the second portion of the user’s body comprises the user’s face. In some embodiments, the second portion includes a first side, a second side, and an opening between the first side and the second side that is configured to receive a user’s hand. In some embodiments, the second portion includes a second edge coupled to the first edge. In some embodiments, the second portion is smaller than the first portion.

In any of the various embodiments disclosed herein, the towel system may include a loop disposed such that, when the towel system is hanging, a first side of the second portion faces away from a first side of the first portion and a second side of the second portion faces a second side of the first portion.

In any of the various embodiments disclosed herein, the second portion may have a fabric density that is different than a fabric density of the first portion.

In any of the various embodiments disclosed herein, the towel system includes a loop for hanging the towel system and the loop may be disposed proximate to the coupling between the first edge and the second edge.

Some embodiments are directed to a towel system that includes a first portion that includes a first material and a second portion that includes a second material that may have a different density than the first material. In some embodiments, the second portion may be smaller than the first portion, and the second portion may be coupled to the first portion. In some embodiments, a first edge of the second portion may be disposed within a perimeter of the first portion and a second edge of the second portion may be disposed within a perimeter of the first portion. In some embodiments, wherein the first edge of the second portion and the second edge of the second portion may be perpendicular.

In any of the various embodiments disclosed herein, the second portion may include a loop, a strap, or a pocket.

In any of the various embodiments disclosed herein, the first portion may be fixedly coupled to the second portion.

### BRIEF DESCRIPTION OF THE FIGURES

The accompanying drawings, which are incorporated herein and form a part of the specification, illustrate the present disclosure and, together with the description, further serve to explain the principles thereof and to enable a person skilled in the pertinent art to make and use the same.

FIG. 1 illustrates a towel system according to some embodiments.

FIG. 2 illustrates a towel system according to some embodiments.

FIG. 3 illustrates a towel system according to some embodiments.

FIG. 4 illustrates a towel system according to some embodiments.

FIG. 5 illustrates a towel system according to some embodiments.

FIG. 6A illustrates a towel system according to some embodiments.

FIG. 6B illustrates a top-down view of the towel system of FIG. 6A.

FIG. 6C illustrates a side view of the towel system of FIG. 6A.

FIG. 7A illustrates a towel system according to some embodiments.

FIG. 7B illustrates a bottom-up view of the towel system of FIG. 7A.

FIG. 7C illustrates a side view of the towel system of FIG. 7A.

FIG. 8A illustrates a towel system according to some embodiments.

FIG. 8B illustrates a bottom-up view of the towel system of FIG. 8A.

FIG. 8C illustrates a side view of the towel system of FIG. 8A.

FIG. 9A illustrates a front view of a towel system according to some embodiments.

FIG. 9B illustrates a back view of the towel system of FIG. 9A.

FIG. 9C illustrates a side view of the towel system of FIG. 9A.

FIG. 10A illustrates a front view of a towel system according to some embodiments.

FIG. 10B illustrates a back view of the towel system of FIG. 10A.

FIG. 10C illustrates a side view of the towel system of FIG. 10A.

FIG. 11 illustrates a towel system according to some embodiments.

FIG. 12A illustrates a front view of a towel system according to some embodiments.

FIG. 12B illustrates a back view of the towel system of FIG. 12A with the second portion folded down.

FIG. 12C illustrates a side view of the towel system of FIG. 12A.

FIG. 13A illustrates a perspective view of a towel system in the open state according to some embodiments.

FIG. 13B illustrates a front view of the towel system of FIG. 13A.

FIG. 13C illustrates a back view of the towel system of FIG. 13A.

FIG. 13D illustrates a left side view of the towel system of FIG. 13A.

FIG. 13E illustrates a right side view of the towel system of FIG. 13A.

FIG. 13F illustrates a top-down view of the towel system of FIG. 13A.

FIG. 13G illustrates a bottom-up view of the towel system of FIG. 13A.

FIG. 13H illustrates a front view of the towel system of FIG. 13A in the folded state.

FIG. 13I illustrates a back view of the towel system of FIG. 13H.

FIG. 13J illustrates the towel system of FIG. 13A.

FIG. 13K illustrates the towel system of FIG. 13A hanging by a loop.

FIG. 13L illustrates the towel system of FIG. 13A hanging by a loop.

FIG. 13M illustrates the towel system of FIG. 13A hanging by a loop.

### DETAILED DESCRIPTION

References in the specification to “one embodiment,” “an embodiment,” “an example embodiment,” “some embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, such feature, structure, or characteristic can be incorporated into other embodiments whether or not explicitly described. Further, features, structures, or characteristics with like reference numbers are intended to have similar features regardless whether the feature is fully described for a specific embodiment.

Towels are routinely used for drying after a shower or swimming. Such towels are typically used for drying hair, face, chest, back, armpits, buttocks (to include the region between one’s buttocks), frontal “private area”, legs, and feet. The towels, themselves, are dried by hanging the towel on a hook, door, or towel rod, etc. for use again without being washed. This often results in much of the towel being folded onto itself. Such towels are typically uniformly shaped and made of a single material such that the front and back are often times not discernable to the user. This means the user may not know exactly what area of the towel was previously used for wiping down/drying off the various body parts (i.e., a user’s face, buttocks, frontal private area, or feet). Subsequent uses of the same towel could cause a user to wipe their face with the same area of the towel that was previously used to wipe their buttocks, “privates”, or feet. Remnants (bodily secretion, pubic hair, buttocks hair, dirt, fungus, etc.) from the towel’s previous use can remain on the towel from the prior use. Subsequent uses of a bath/swim towel can cause said remnants to then be transferred to one’s face (one of the most highly regarded and sensitive areas of the human body).

Embodiments described herein overcome these and other challenges by providing—among other benefits—a towel system that includes a first portion for drying a user’s body and second portion for drying a user’s face. The towel system may include other features (e.g., loops) that allow the towel system to hang without contact between at least one side of the second portion and at least one portion of the first portion. Such towel systems may be used in various settings, including a user’s home, workout facilities (e.g., gyms, locker rooms), spas, hotels, hospitals, etc. When used for drying a user’s body, the first portion and the second portion for drying different parts of a user’s body. In other applications (e.g., gyms) one portion may be used for wiping sweat from a user’s face while the other portion may be used to wipe down workout equipment.

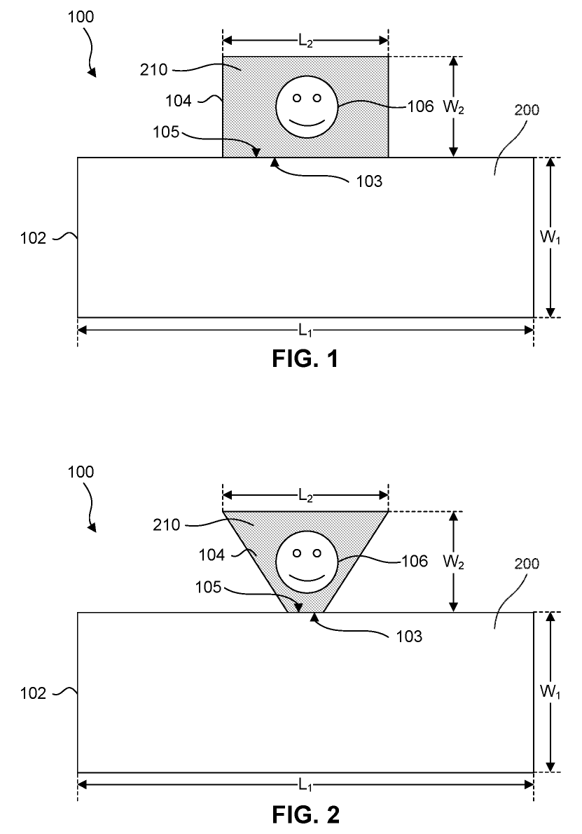

FIG. 1 illustrates a towel system 100 according to some embodiments. In some embodiments, towel system 100 may include a first portion 102 and a second portion 104. First portion 102 may have a rectangular shape, as shown in FIG. 1, or any other shape. Second portion 104 may have a rectangular shape, as shown in FIG. 1, or a non-rectangular shape for example, trapezoidal, triangular, elliptical, circular, or irregular curvilinear shape. In some embodiments, first portion 102 is a larger portion that is for drying a user’s body, and second portion 104 is a smaller portion that is for drying a user’s face. The rectangular second portion 104 may be external to the perimeter of first portion 102. In some embodiments, as shown in FIG. 1, second portion 104 may extend from an edge 103 of first portion 102.

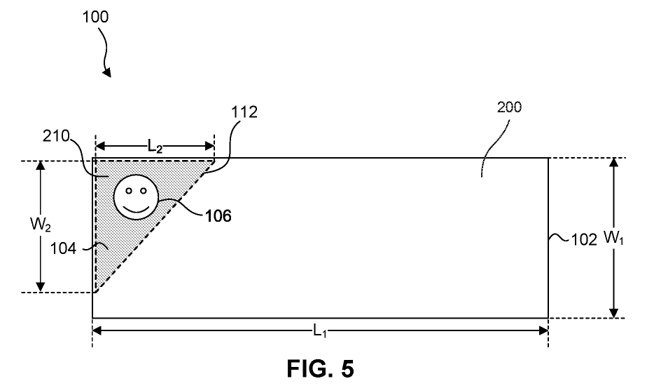

First portion 102 may have a front side 200 and a back side 202. Second portion 104 may have a front side 210 and a back side 212. In some embodiments, first portion 102 and second portion 104 may consist of a single layer of water absorbing material and may be fabricated as a whole unit from the same sheet of material. First portion 102 and second portion 104 may be single layer or multi-layer. In some embodiments, first portion 102 is a single layer. In some embodiments, as shown in FIGS. 4 and 5, the second portion may be coupled to a side of first portion 102 such that first portion 102 and second portion 104 together form a multi-layer of towel system 100.

Towel system 100 may be made of various materials having certain characteristics (e.g., fabric types, fabric densities, and/or pile heights). In some embodiments, first portion 102 and second portion 104 are made of the same material. In some embodiments, first portion 102 and second portion 104 are made of different materials. In some embodiments, first portion 102 is made of at least one of cotton, terry cloth, bamboo, microfiber materials, polyester blend, or combinations thereof. In some embodiments, second portion 104 is made of at least one of cotton, terry cloth, bamboo, microfiber materials, polyester blend or combinations thereof. In other embodiments, first portion 102 and second portion 104 are formed from two separate layers of material coupled, fixedly or removably, together, for example, along an edge of first portion 102 and edge of second portion 104. The second portion 104 may be positioned in various other locations other than as shown throughout the figures. For example, as shown throughout the figures, the second portion may be coupled to first portion 102 along a long side of first portion 102. In some embodiments, the second portion 104 may be coupled to first portion 102 along the short side of first portion 102.

First portion 102 may be fixedly coupled to a second portion 104. For example, first portion 102 may be fixedly coupled to the second portion by coupling 112. In some embodiments, coupling 112 comprises stitches, adhesive, or a combination thereof. In some embodiments, an edge (e.g., edge 103) of first portion 102 is coupled to an edge (e.g., edge 105) of the second portion.

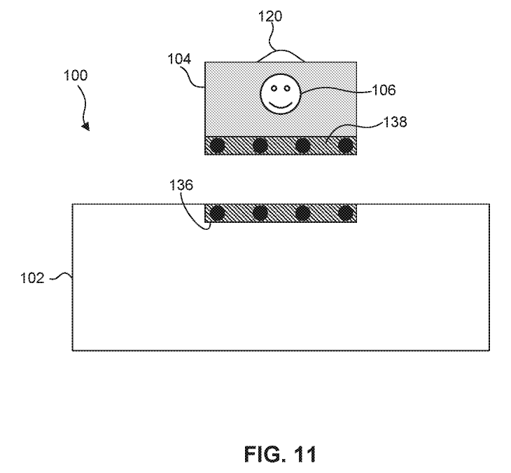

First portion 102 may be removably coupled to a second portion 104. For example, as shown in FIG. 11, first portion 102 may include first fastener 136 and the second portion 104 may include second fastener 138. In some embodiments, first fastener 136 and second fastener 138 may removably couple to each other. In some embodiments, first fastener 136 and/or second fastener 138 may include adhesive strips, snap-fit connectors, hook and loop fasteners, a zipper, an adhesive, or buttons.

First portion 102 may be integral with a second portion 104. For example, first portion 102 and the second portion may be made of a single continuous piece of material that is cut to the appropriate shape.

In some embodiments, first portion 102 has length (L₁) ranging from about 48 inches to about 72 inches and width (W₁) ranging from about 30 inches to about 42 inches. In some embodiments, second portion 104 has a length (L₂) ranging from about 12 inches to about 36 inches and a width (W₂) ranging from about 12 inches to about 36 inches. In some embodiments, as shown in FIG. 1, the length (L₁) of first portion 102 is greater than the length (L₂) of second portion 104, and the width (W₁) of first portion 102 is greater than the width (W₂) of second portion 104.

FIG. 2 illustrates a towel system 100 according to some embodiments. In some embodiments, towel system 100 may include first portion 102 and second portion 104. In some embodiments, as shown in FIG. 2, second portion 104 may have a trapezoidal shape (as shown in FIG. 2). Second portion 104 is shown in FIG. 2 coupled to first portion 102 by the shorter base of the trapezoidal shape. In some embodiments, second portion 104 is coupled to first portion 102 by the longer base.

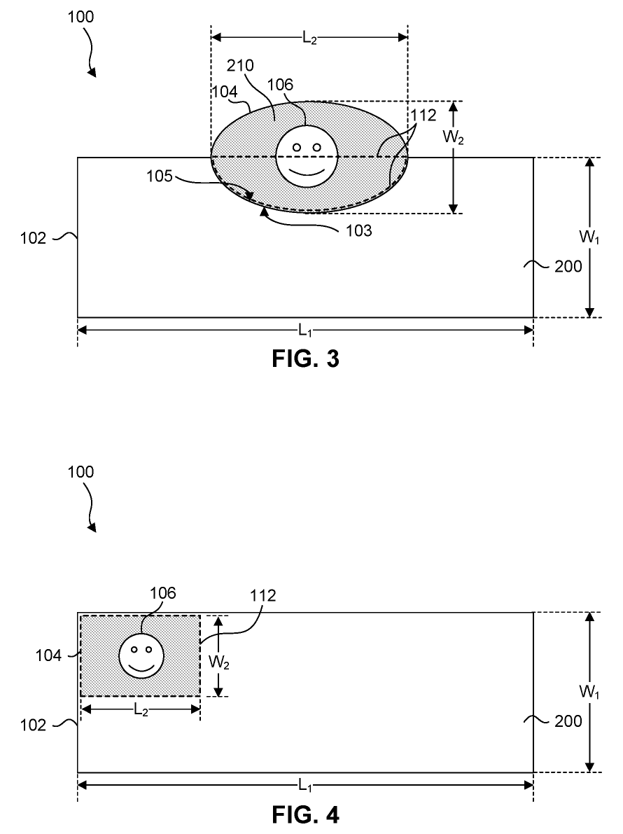

FIG. 3 illustrates a towel system 100 according to some embodiments. In some embodiments, towel system 100 may include first portion 102 and second portion 104. In some embodiments, as shown in FIG. 3, second portion 104 may have an elliptical shape. In some embodiments, at least a portion of second portion 104 overlaps a portion of first portion 102. In some embodiments, as shown in FIG. 3, a portion of second portion 104 is external to the perimeter of first portion 102 and another portion of second portion 104 is internal to the perimeter of first portion 102.

In some embodiments, as shown in FIG. 3, a portion of second portion 104 may be coupled to front side 200 of first portion 102. The overlapping portion of second portion 104 can be coupled to front side 200 along coupling 112. In some embodiments, coupling 112 secures the overlapping portion of second portion 104 to first portion 102. Although second portion 104 is shown at the center of the top side of first portion 102, second portion 104 may be positioned at different locations along the perimeter of first portion 102 (e.g., at a corner of first portion 102).

FIG. 4 illustrates a towel system 100 according to some embodiments. In some embodiments, towel system 100 may include first portion 102 and second portion 104. In some embodiments, as shown in FIG. 4, second portion 104 is a rectangle and may be coupled to front side 200 of first portion 102. Rectangular insert 104 may be positioned entirely internal to the perimeter of first portion 102 as shown in FIG. 4. The back side of second portion 104 faces front side 200 of first portion 102. Second portion 104 is coupled to front side 200 along coupling 112 along the perimeter of second portion 104. Although second portion 104 is shown at a corner of first portion 102, second portion 104 may be positioned at different locations within the perimeter of first portion 102 (e.g., centrally located along one side of first portion 102).

FIG. 5 illustrates a towel system 100 according to some embodiments. In some embodiments, towel system 100 may include first portion 102 and second portion 104. Second portion 104 may have a triangular shape. In some embodiments, as shown in FIG. 5, second portion 104 (and/or first portion 102 can have indicia 106, e.g., symbol, graphic, or alphanumerical text, configured to identify the portion of towel system 100 that is for drying a user’s face.

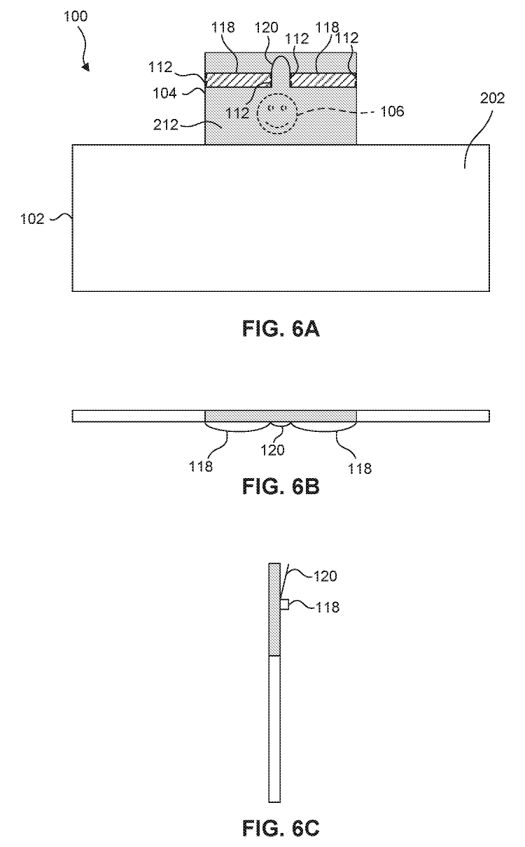

FIGS. 6A-6C illustrates a towel system 100 according to an embodiment. As shown in FIG. 6A, second portion 104 may include one or more handholds or handles (e.g., strap handles 118) and one or more loops (e.g., loop 120). In some embodiments, strap handles 118 and loop 120 are disposed on back side 212 of second portion 104. FIG. 6B illustrates a top-down view of the towel system shown in FIG. 6A. FIG. 6C illustrates a side view of the towel system shown in FIG. 6A.

Strap handles 118 may allow a user to manipulate second portion 104 independently of first portion 102. In some embodiments, strap handles 118 are coupled to second portion 104 by coupling 112, for example, stitching or adhesive. Strap handles 118 may be gripped by a user while drying the user’s face. The strap handles 118 may be open in the middle and sized to accommodate a wide range of hand sizes. In one embodiment, the strap handles 118 may have a width from about 2 inches to about 4 inches. Strap handles 118 may be made of the same material as first portion 102 and/or second portion 104, or strap handles 118 may be made of a different material than first portion 102 and/or second portion 104.

Loop 120 is configured to hang towel system 100 for drying. In some embodiments, loop 120 is positioned such that, when towel system 100 is hanging from loop 120, front side 210 and/or back side 212 of second portion 104 do not contact first portion 102. This may ensure that both portions of the towel system 100 can hang freely, promoting air circulation and faster drying and reduces cross-contamination between first portion 102 and second portion 104. In some embodiments, as shown in FIG. 6A, loop 120 is disposed between strap handles 118, and at the midpoint of the length of second portion 104.

As shown throughout the figures, towel system 100 may include one or more loops (e.g., loops 120, 121, or 122). In some embodiments, when towel system 100 is hanging from loop 120 or loop 122 neither side (e.g., front side 210 or back side 212) of the second portion 104 contacts first portion 102. In some embodiments, when towel system 100 is hanging from loop 121, front side 210 of the second portion 104 does not contact first portion 102, while back side 212 of second portion 104 contacts first portion 102. In some embodiments, the position of each of loops 120, 121, and/or 122 allows a user to quickly and easily access second portion 104 while towel system 100 is hanging via any one of loops 120, 121, and 122, for example, while shaving, washing the user’s face, or brushing the user’s teeth.

Any of the embodiments shown throughout the figures may include one or more (e.g., two, three, or more than three) loops.

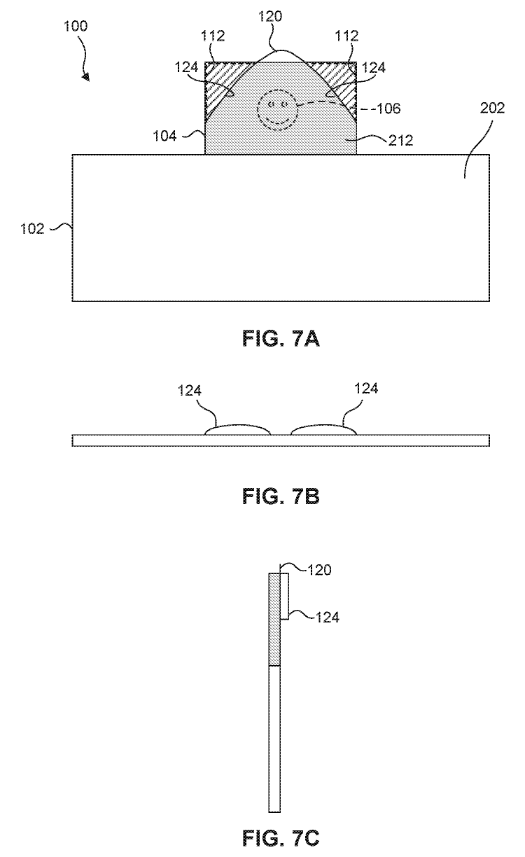

FIGS. 7A-7C illustrates towel system 100 according to an embodiment. For example, as shown in FIG. 7A, second portion 104 may include one or more pockets (e.g., pockets 124) and one or more loops (e.g., loop 120). In some embodiments, pockets 124 and loop 120 are disposed on back side 212 of second portion 104. FIG. 7B illustrates a bottom-up view of the towel system shown in FIG. 7A. FIG. 7C illustrates a side view of the towel system shown in FIG. 7A.

In some embodiments, pockets 124 are coupled to second portion 104 by coupling 112. Pockets 124 may be made of the same material as first portion 102 and/or second portion 104, or pockets 124 may be made of a different material than first portion 102 and/or second portion 104. In some embodiments, pockets 124 may be triangular in shape with one side being open to receive a user’s hand and the other two sides being closed off via coupling 112, as shown in FIG. 7A. In some embodiments, pockets 124 may be made using separate pieces that are coupled to second portion 104 by coupling 112. In some embodiments, pockets 124 may be made by folding over the fabric that forms second portion 104 and coupling the fabric to itself. Loop 120 can extend from a top edge of second portion 104.

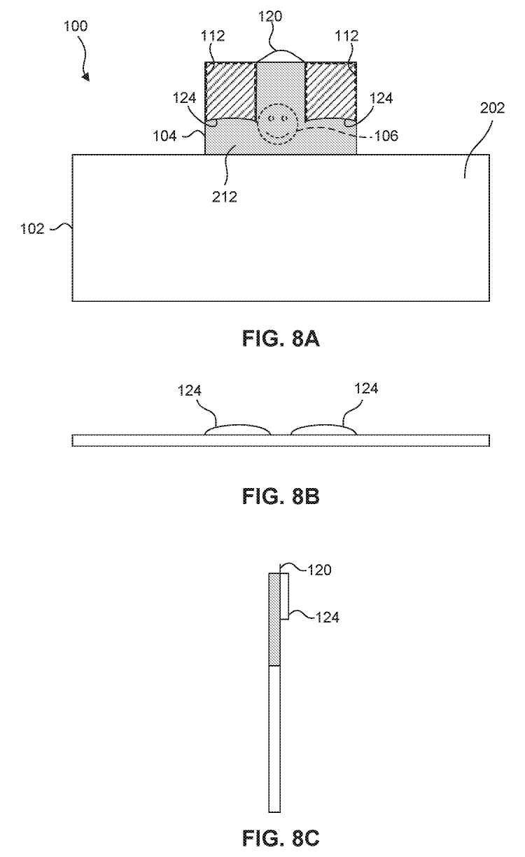

FIGS. 8A, 8B and 8C illustrate towel system 100 according to an embodiment. As shown in FIGS. 8A-8C, pockets 124 may have a rectangular shape.

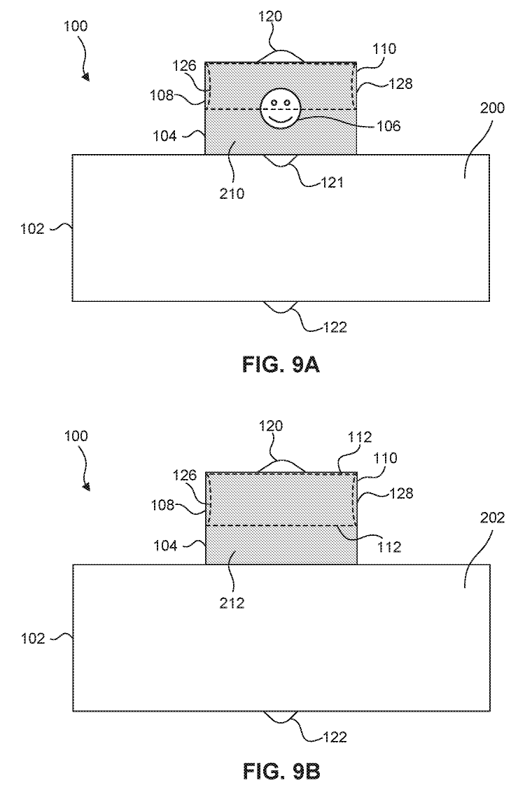

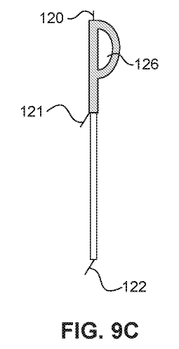

FIGS. 9A-9C illustrate towel system 100 according to an embodiment. FIG. 9A illustrates a front side of towel system 100. Second portion 104 may include an opening (e.g., opening 126) extending along the length (L₂shown in FIG. 1) of second portion 104, and one or more loops (e.g., loops 120, 121, and 122). In some embodiments, opening 126 defines a loop or a tube. In some embodiments, opening 126 creates a sleeve for receiving a user’s hand and/or arm. In some embodiments, opening 126 extends from at a first side 108 of second portion 104 to a second side 110 of second portion 104. In some embodiments, second portion 104 includes a reinforced outer edging (e.g., edging 128). FIG. 9B illustrates a back side of the towel system shown in FIG. 9A. FIG. 9C illustrates a side view of the towel system shown in FIG. 9A.

Opening 126 may be shaped and sized to allow users to insert their hands while maintaining. Opening 126 allows a user to manipulate second portion 104 independently of first portion 102. In some embodiments, opening 126 has a width equal to the width of second portion 104. In some embodiments, opening 126 has a width less than the width of second portion 104. In some embodiments, opening 126 has a height from about 4 inches to about 8 inches. In some embodiments, opening 126 may be defined by a space between a first piece of fabric and a separate, second piece of fabric that is coupled to the first piece (e.g., by coupling 112) to form second portion 104. In some embodiments, opening 126 may be made by folding over the fabric that forms second portion 104 and coupling the fabric to itself, thereby defining opening 126.

As shown in FIGS. 9A, loop 120 may be disposed at a top end of second portion 104, loop 121 may be disposed at the coupling between first portion 102 and second portion 104, and loop 122 may be disposed at a bottom end of first portion 102. Each of the loops may be positioned such that when towel system is hanging from any one of these loops, at least one side of second portion 104 does not contact first portion 102.

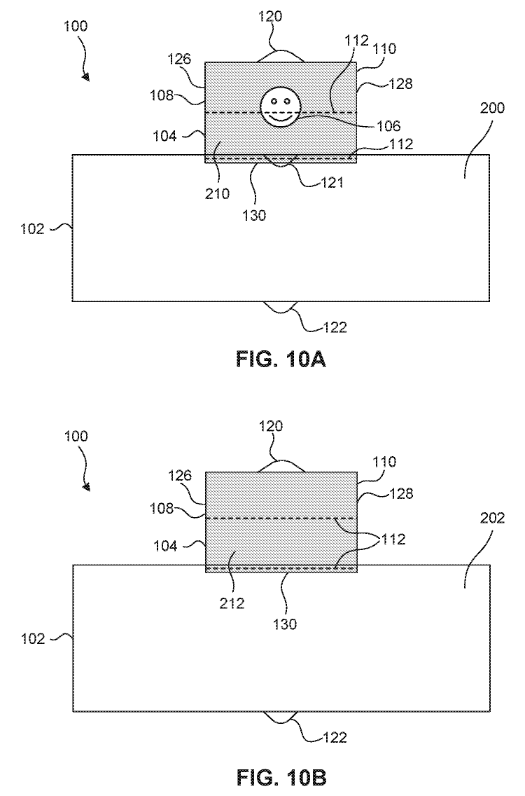

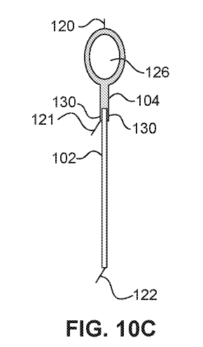

FIGS. 10A-10C illustrate towel system 100 according to an embodiment similar to towel system 100 shown in FIGS. 9A-9C, including opening 126 and loops 120, 121, and 122. However as shown in FIGS. 10A-10C, second portion 104 may be made by folding the fabric over and coupling the free ends 130 to a top edge of first portion 102, thereby sandwiching the top edge between the free ends 130 of second portion 104 (as best seen in FIG. 10C). In some embodiments, at least a portion of first portion 102 is disposed between two layers of second portion 104. In some embodiments, coupling 112 secures the free ends 130 to first portion 102 such that first portion 102 is disposed between the two layers of second portion 104.

FIG. 11 illustrates a towel system 100 according to some embodiments. As shown in FIG. 11, second portion 104 may be removably coupled to first portion 102. Second portion 104 may be rectangular, as shown in FIG. 11, or may be any other shape discussed throughout other embodiments disclosed here.

First portion 102 and second portion 104 may be removably coupled to each other using various coupling mechanisms. In some embodiments, first portion 102 includes at least one first fastener 136, and second portion 104 includes at least one second fastener 138. In some embodiments, first fastener 136 and/or second fastener 138 may include adhesive strips, snap-fit connectors, hook and loop fasteners, a zipper, an adhesive, or buttons. In some embodiments, multiple second portions 104 may be removably coupled to first portion 102. In some embodiments, first fastener 136 may be applied to an existing towel to convert an existing towel into towel system 100. In some embodiments, second fastener 138 may be applied to a second existing towel to convert the first and second existing towels into towel system 100.

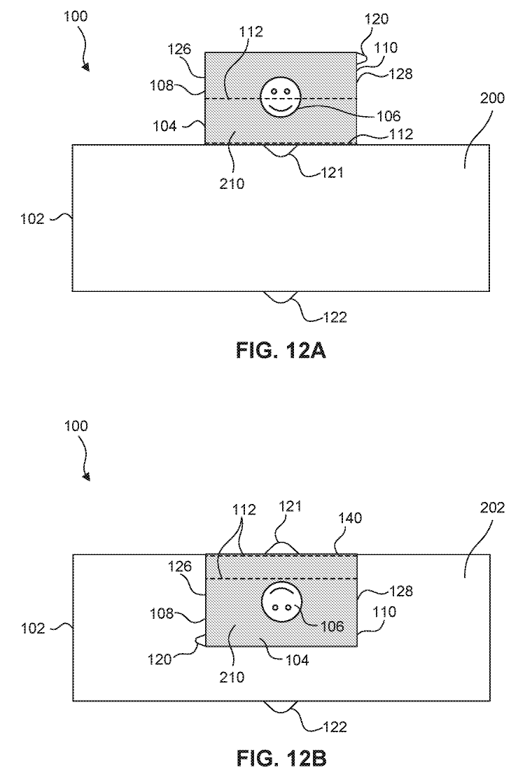

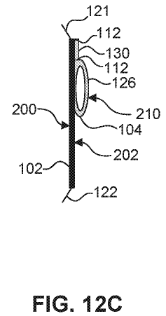

FIGS. 12A-12C illustrates towel system 100 according to an embodiment. In this embodiment, loop 120 is positioned at one side edge of second portion 104, for example, at a corner of second portion 104 opposite from first portion 102. FIG. 12C illustrates a side view of towel system 100 when second portion 104 is folded over. As shown in FIG. 12, when folded and/or hanging by loop 121, front side 210 of second portion 104 does not contact backside 202 of first portion 102.

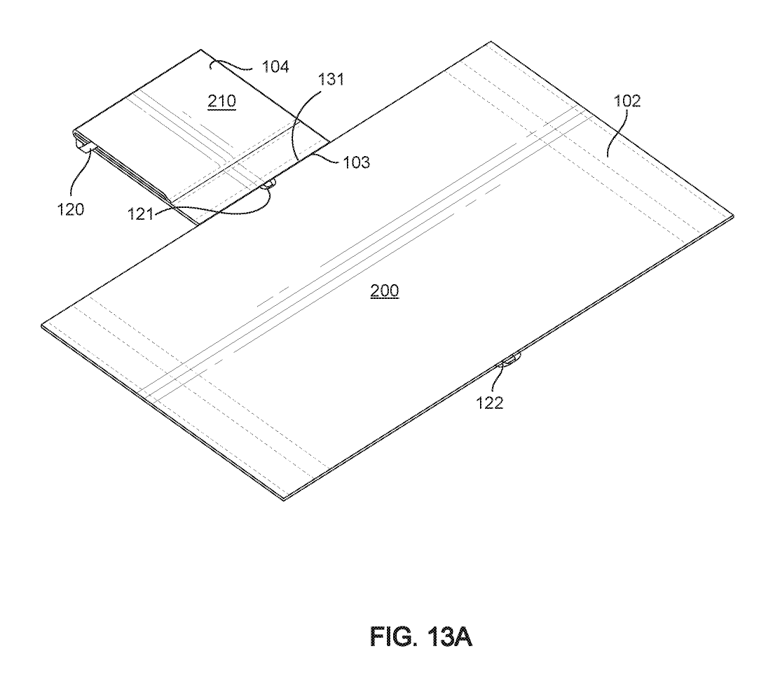

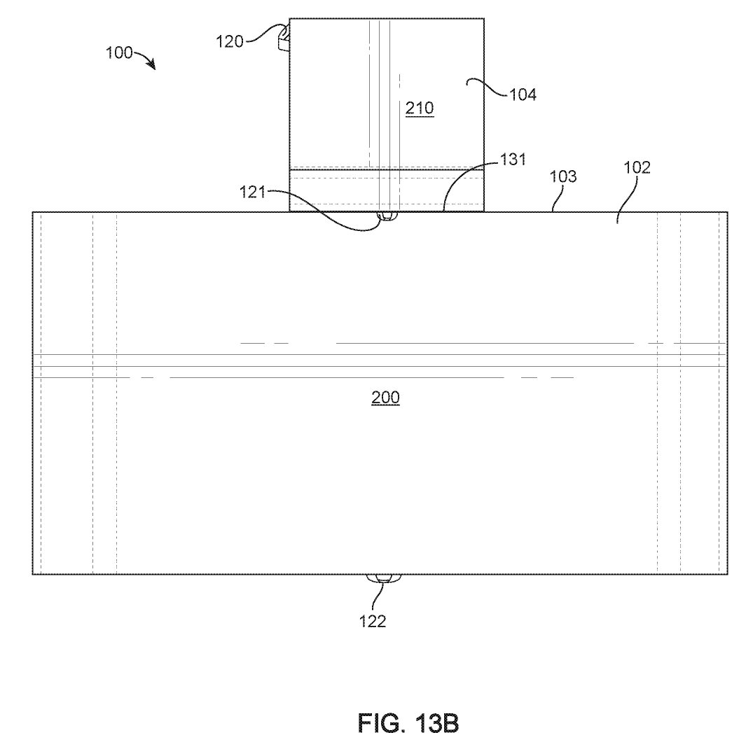

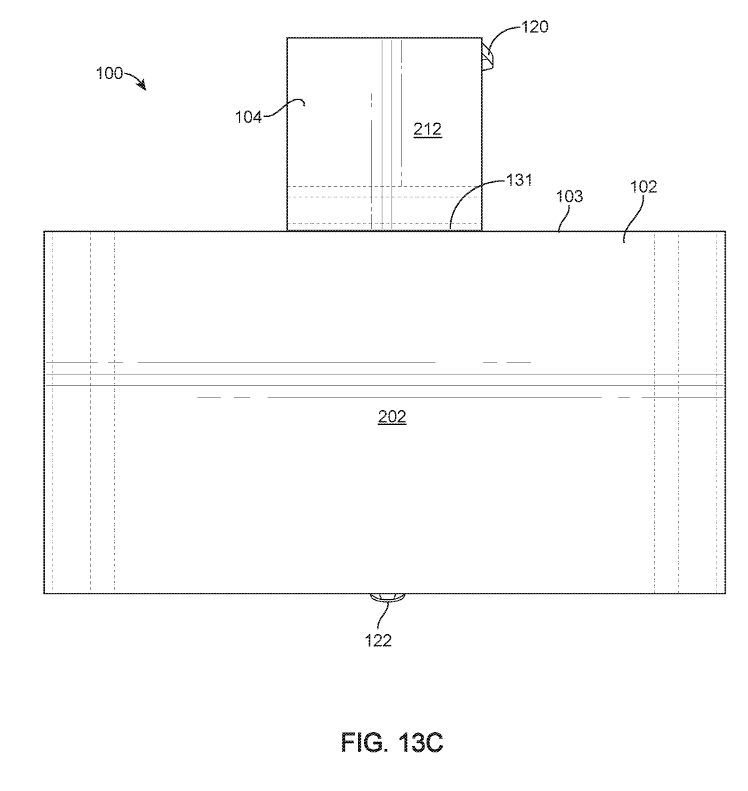

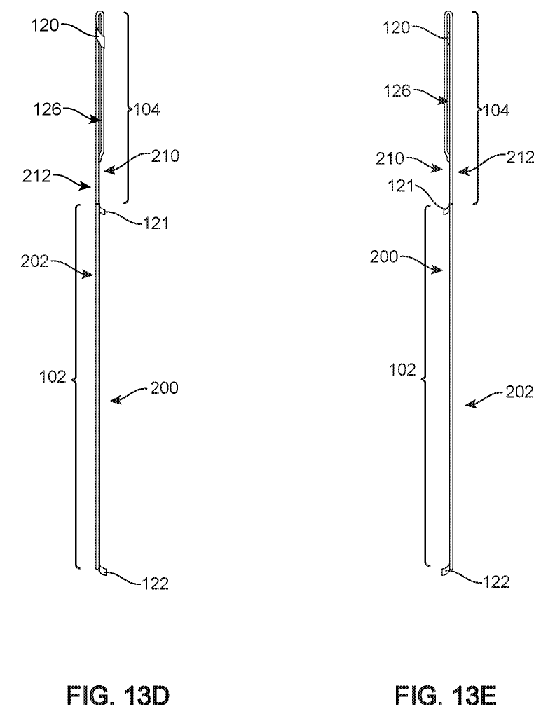

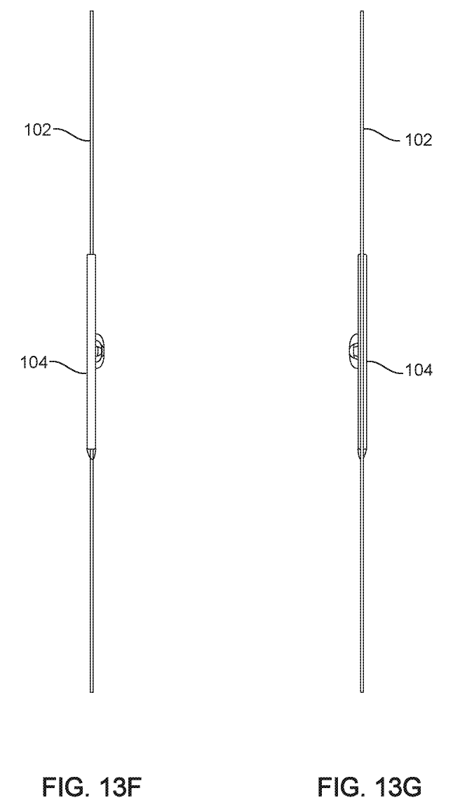

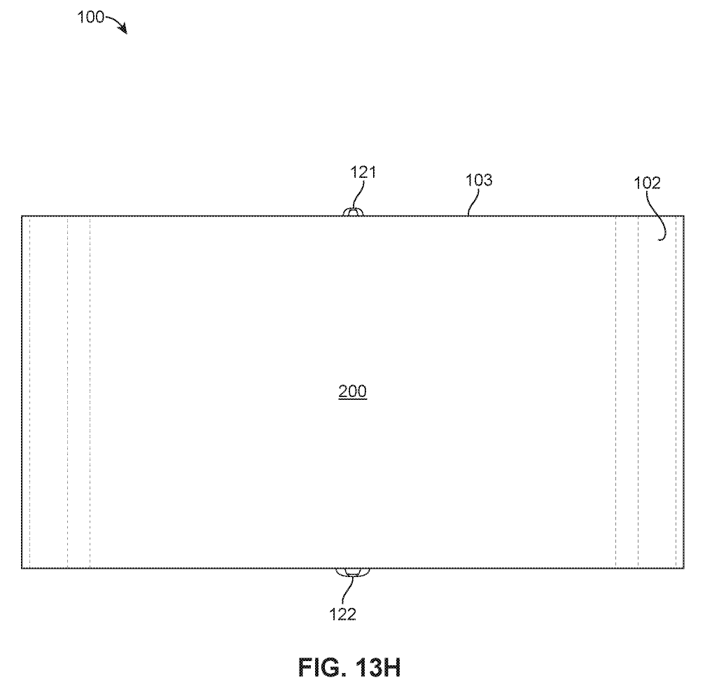

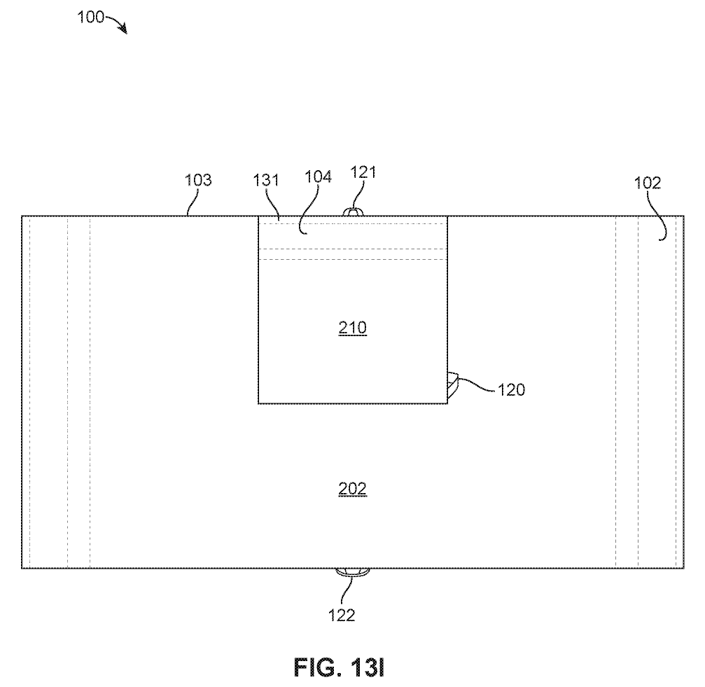

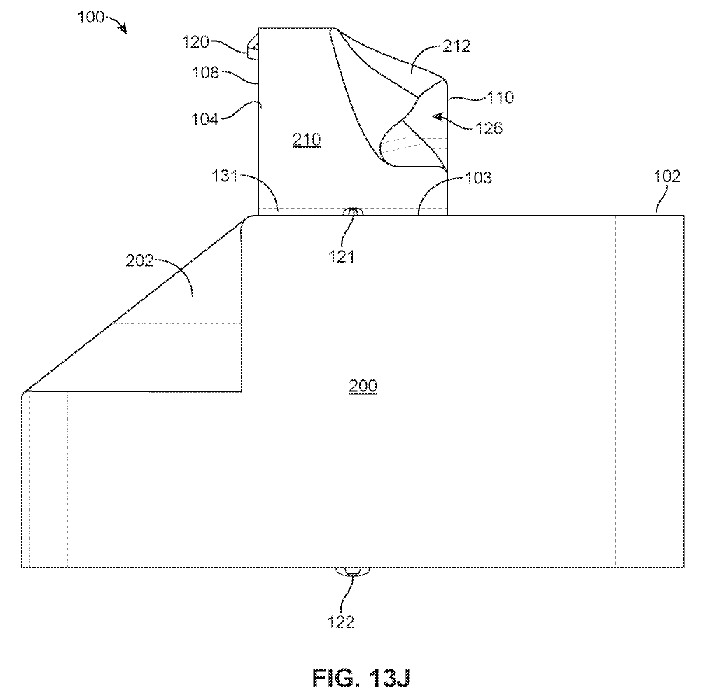

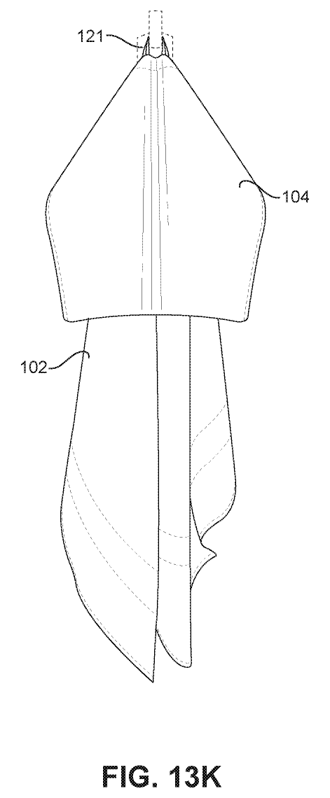

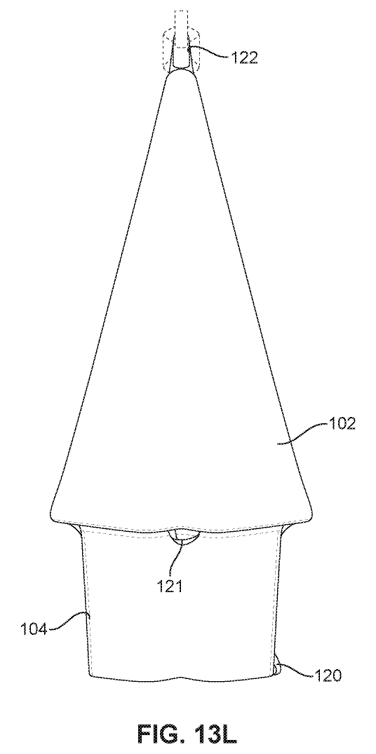

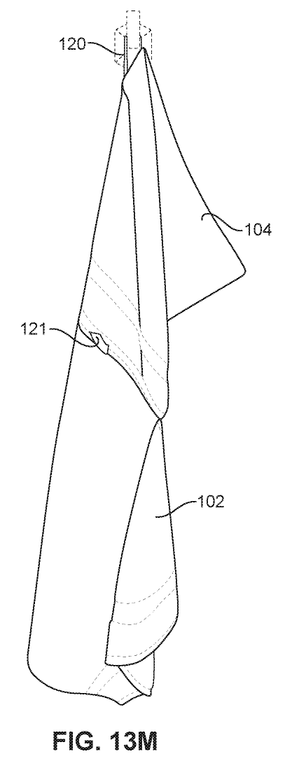

FIGS. 13A-13M show various views of a towel system 100 according to some embodiments. As shown in FIGS. 13A-13G, towel system 100 is in an expanded laid out position and including first portion 102, second portion 104, loops 120, 121, and 122, and opening 126. As shown in FIGS. 13H and 13I, towel system 100 is in a folded position (i.e., second portion 104 is folded over first portion 102). Edge 103 of first portion 102 is coupled to edge 131 of second portion 104. As shown in FIGS. 13D, 13E, and 13J, towel system 100 may include opening 126. FIG. 13K shows towel system 100 hanging by loop 121. FIG. 13L shows towel system 100 hanging from loop 122. FIG. 13M shows towel system 100 hanging from loop 120. As shown in FIGS. 13K-13M, the position of loops 120, 121, and 122 allows a user to manipulate second portion 104 independently of first portion 102 while towel system 100 is hanging via any one of loops 120, 121, and 122. This allows a user to quickly and easily access second portion 104 while towel system 100 is hanging, for example, while shaving, washing the user’s face, or brushing the user’s teeth.

In some embodiments, first portion 102 and second portion 104 have the same fabric density. In some embodiments, first portion 102 and second portion 104 have different fabric densities. In some embodiments, first portion 102 has a fabric density from about 50 grams per square meter (GSM) to about 1000 GSM, from about 300 GSM to about 900 GSM, from about 400 GSM to about 750 GSM, from about 500 GSM to about 600 GSM, or within a range having any two of these values as endpoints. In some embodiments, second portion 104 has a fabric density from about 300 grams per square meter (GSM) to about 900 GSM, from about 400 GSM to about 750 GSM, from about 500 GSM to about 600 GSM, or within a range having any two of these values as endpoints. In some embodiments, first portion 102 has a fabric density of at least 50 GSM, at least 300 GSM, at least 500 GSM, or at least 750 GSM. In some embodiments, second portion 104 has a fabric density of at least 50 GSM, at least 300 GSM, at least 500 GSM, or at least 750 GSM. In some embodiments, second portion 104 has a different fabric density than first portion 102. In some embodiments, second portion 104 has a higher fabric density than first portion 102. In some embodiments, second portion 104 has a lower fabric density than first portion 102.

In some embodiments, first portion 102 and second portion 104 have the same pile height. In some embodiments, first portion 102 and second portion 104 have different pile heights. In some embodiments, first portion 102 has a pile height from about 5 mm to about 20 mm, from about 8 mm to about 20 mm, from about 12 mm to about 15 mm, or within a range having any two of these values as endpoints. In some embodiments, second portion 104 has a pile height from about 5 mm to about 20 mm, from about 8 mm to about 20 mm, from about 12 mm to about 15 mm, or within a range having any two of these values as endpoints. In some embodiments, second portion 104 has a different pile height than first portion 102. In some embodiments second portion 104 has a higher pile height than first portion 102. In some embodiments second portion 104 has a lower pile height than first portion 102.

As used herein, the terms “top” and “bottom,” and the like are intended to assist in understanding of embodiments of the disclosure with reference to the accompanying drawings with respect to the orientation of as shown, and are not intended to be limiting to the scope of the disclosure or to limit the disclosure scope to the embodiments depicted in the Figures. The directional terms are used for convenience of description and it is understood that the towel system may be positioned in any of various orientations.

It is to be appreciated that the Detailed Description section, and not any other section, is intended to be used to interpret the claims. Other sections may set forth one or more but not all exemplary embodiments of the present disclosure as contemplated by the inventor(s), and thus, are not intended to limit the present disclosure and the appended claims in any way.

The present disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The above examples are illustrative, but not limiting, of the present disclosure. Other suitable modifications and adaptations of the variety of conditions and parameters normally encountered in the field, and which would be apparent to those skilled in the art, are within the spirit and scope of the disclosure.

The breadth and scope of the present disclosure should not be limited by any of the above-described exemplary embodiments, but should be defined only in accordance with the claims and their equivalents.

What is claimed is:

1. A towel system comprising:
a first portion having a first length and a first width;
a second portion having a second length and a second width,
wherein the first length is greater than the second length,
wherein the first width is greater than the second width, and
wherein an edge of the second portion is coupled to an edge of the first portion;
a loop for hanging the towel system, wherein the loop is disposed proximate to the coupling between the edge of the first portion and the edge of the second portion.

2. The towel system of claim 1, wherein the first portion has a density from 50 GSM to 1000 GSM, and wherein the second portion has a density from 50 GSM to 1000 GSM.

3. The towel system of claim 2, wherein the second portion has a fabric density different than a fabric density of the first portion.

4. The towel system of claim 1, wherein the first portion is made of a first material and the second portion is made of a second material that is different than the first material.

5. The towel system of claim 1, wherein the second portion is removably coupled to the first portion.

6. The towel system of claim 5, wherein the second portion is removably coupled by a fastening system.

7. The towel system of claim 6, wherein the fastening system comprises at least one of a snap fit fastener, a hook and loop fastener, a zipper, an adhesive, or combinations thereof.

8. The towel system of claim 1, wherein the second portion is fixedly coupled to the first portion.

9. The towel system of claim 8, wherein the second portion is fixedly coupled by at least one of stitching, adhesive, or a combination thereof.

10. The towel system of claim 1, wherein the second portion is one of a rectangular shape, a trapezoidal shape, a triangular shape, an elliptical shape, or an oval shape.

11. The towel system of claim 1, wherein the second portion comprises a first side, a second side, and an opening between the first side and the second side that is configured to receive a user’s hand.

12. The towel system of claim 1, further comprising a pocket coupled to the second portion configured to receive a user’s hand.

13. The towel system of claim 1, wherein the loop is disposed proximate to the coupling between the edge of the first portion and the edge of the second portion such that, when the towel system is hanging, a first side of the second portion faces away from a first side of the first portion and a second side of the second portion faces a second side of the first portion.

14. A towel system, comprising:
a first portion configured to dry a first body portion of a user’s body, the first portion comprising a first edge;
a second portion extending out from the first portion and configured to dry a second body portion of the user’s body different than the first body portion, the second portion comprising:
a first side, a second side, and an opening between the first side and the second side that is configured to receive a user’s hand,
wherein the second portion is smaller than the first portion.

15. The towel system of claim 14, further comprising a loop disposed such that, when the towel system is hanging, a first side of the second portion faces away from a first side of the first portion and a second side of the second portion faces a second side of the first portion.

16. The towel system of claim 14, wherein the second portion has a fabric density that is different than a fabric density of the first portion.

17. The towel system of claim 14, further comprising a loop for hanging the towel system,
wherein the second portion further comprises a second edge coupled to the first edge of the first portion, and
wherein the loop is disposed proximate to the coupling between the first edge and the second edge.

18. The towel system of claim 14, wherein the second portion is configured to dry a user’s face.

19. A towel system, comprising:
a first portion comprising a first material;
a second portion comprising a second material that has a different density than the first material, wherein the second portion is smaller than the first portion, wherein the second portion is coupled to the first portion; and
wherein a first edge of the second portion is disposed within a perimeter of the first portion,
wherein a second edge of the second portion is disposed within a perimeter of the first portion, and
wherein the first edge of the second portion and the second edge of the second portion are perpendicular.

20. The towel system of claim 19, wherein the second portion comprises a loop, a strap, or a pocket.

21. The towel system of claim 19, wherein the first portion is fixedly coupled to the second portion.
